(19) United States
(12) Patent Application Publication
(10) Pub. No.: US 2026/0088637 A1
(43) Pub. Date: Mar. 26, 2026

(54) UNDERGROUND LAMP STORAGE AND CHARGING SYSTEM

(71) Applicant: METROMAX AMERICA CORPORATION, ROWLAND HEIGHTS, CA (US)

(72) Inventor: Christina HWANG, ROWLAND HEIGHTS, CA (US)

(73) Assignee: METROMAX AMERICA CORPORATION, ROWLAND HEIGHTS, CA (US)

(21) Appl. No.: 18/897,663

(22) Filed: Sep. 26, 2024

(51) Int. Cl. H02J 7/00

(52) U.S. Cl. CPC H02J 7/70

(57) ABSTRACT

An underground lamp storage and charging system includes a box and a multiple of underground lamps, the box contains a power supply module and a multiple of recessed charging slots formed outside the box and provided for detachably fixing an underground lamp, each charging slot is provided with a positioning part and a first terminal group electrically connected to the power supply module, each underground lamp is provided with a positioning slot and a second terminal group, such that the power supply module can supply power to the underground lamp through the first and second terminal group.

### FIELD OF THE DISCLOSURE

The present disclosure relates to the technical field of underground lamp storage and charging systems, and more particularly to an underground lamp storage and charging system provided for storing a multiple of underground lamps and charging the multiple of underground lamps.

### BACKGROUND OF THE DISCLOSURE

Underground lamps are lighting fixtures widely used in outdoor places, and most underground lamps come with a solar charging structure to provide power for lighting through solar energy, and different fasteners can be installed on the back of the underground lamp for plugging and positioning the underground lamp to the ground, or on a wall, such as those disclosed in the U.S. Pat. Nos. 10,619,810, 10,995,918, 11,333,333, and Ser. No. 18/321,065 by the discloser of the present disclosure.

The related-art solar energy charging underground lamps of this kind have the advantages of small size, easy to carry and easy to install, although the internal battery can save electricity, the lamp must be set in the sunshine irradiation condition for normal lighting, resulting in the limited range of the use of the underground lamp. Therefore, the discloser of the present disclosure developed an underground lamp storage and charging system, not only can store and fix multiple underground lamps to facilitate the carrying of the underground lamps, but also can charge the multiple underground lamps simultaneously, allowing the underground lamp to be used indoor or many other places, solving the problem of insufficient solar energy of charging, and expanding the scope of application of the underground lamps.

### SUMMARY OF THE DISCLOSURE

Specifically, the present disclosure provides an underground lamp storage and charging system, including a box and a plurality of underground lamps, the box having an accommodation space defined therein for accommodating a power supply module, a plurality of recessed charging slots formed on the exterior of the box and each charging slot being provided for detachably fixing an underground lamp, wherein:
the charging slot comprises a bottom surface with a first terminal group exposed therefrom and electrically coupled to the power supply module, and a positioning part convexly formed at the center of the bottom surface;
the underground lamp comprises a bottom embeddable into any one of the charging slots, the bottom having a positioning slot configured relative to the positioning part, and a second terminal group configured relative to the first terminal group;
thereby, when the bottom of the underground lamp is embedded into the bottom surface of the charging slot, the positioning part of the charging slot is embedded into the positioning slot of the underground lamp to prevent the underground lamp from falling off, and the first terminal group and the second terminal group are electrically coupled to each other, such that the power supply module can supply power to the underground lamp through the first terminal group and the second terminal group.

Compared with the related art, the present disclosure can simultaneously store plurality of underground lamps through the plurality of charging slots outside the box to facilitate users to carry when going out, and simultaneously charge the plurality of underground lamps, allowing the underground lamps to be used indoors to solve the problem of insufficient solar charging and expands the scope of application of the underground lamps.

The objectives, technical characteristics and effects of the present disclosure will become apparent with the detailed description of preferred embodiments accompanied with the illustration of related drawings.

### BRIEF DESCRIPTION OF THE DRAWINGS

FIG. 1 is a perspective view of the present disclosure;

FIG. 2 is a perspective view of a charging slot and an underground lamp of the present disclosure;

FIG. 3 is a schematic view of an underground lamp embedded into the charging slot of the present disclosure;

FIG. 4 is a schematic view of the underground lamp as depicted in FIG. 3 deflected and positioned relative to the charging slot

FIG. 5 is a schematic view of a rear box casing in accordance with a first embodiment of the present disclosure;

FIG. 6 is a schematic view of the rear box casing in accordance with a second embodiment of the present disclosure; and

FIG. 7 is a schematic view showing the assembly of underground lamp with an external charging cable in accordance with the present disclosure.

### DESCRIPTION OF THE PREFERRED EMBODIMENTS

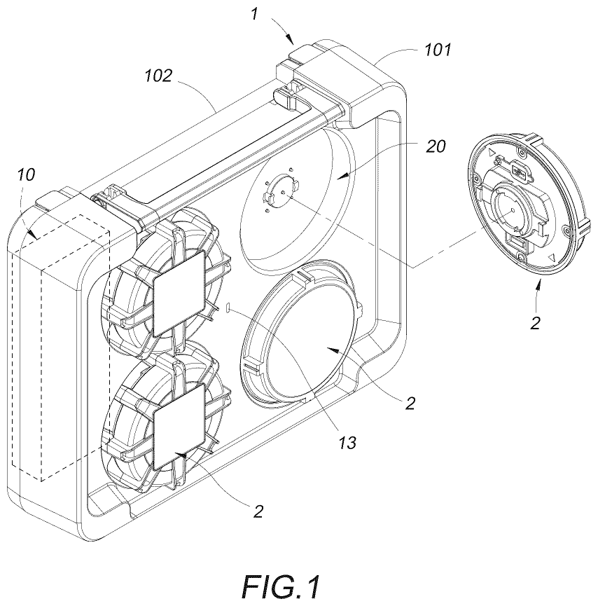

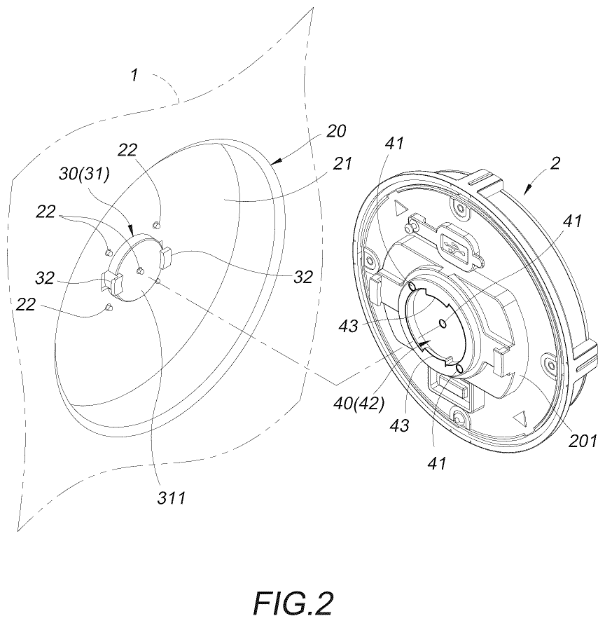

With reference to FIGS. 1 and 2 for an underground lamp storage and charging system of the present disclosure, the underground lamp storage and charging system includes a box 1 and a plurality of underground lamps 2, the box 1 includes a power supply module 10 installed inside the box 1, and a plurality of recessed charging slots 20 formed outside the box 1 and provided for detachably fixing the underground lamps 2 respectively.

The center of the bottom surface 21 of the charging slot 20 is convexly provided with a positioning part 30, and a first terminal group 22 is exposed from the bottom surface 21 and electrically connected to the power supply module 10 inside the box 1.

The bottom 201 of the underground lamp 2 is embeddable in any one of the charging slots 20, and the bottom 201 is provided with a positioning slot 40 configured relative to the positioning part 30, and a second terminal group 41 configured relative to the first terminal group 22.

With the aforementioned structure, when the bottom 201 of the underground lamp 2 is embedded in the bottom surface 21 of the charging slot 20, the positioning part 30 of the charging slot 20 can be embedded in the positioning slot 40 of the underground lamp 2 to prevent the underground lamp 2 from falling off, and the first terminal group 22 and the second terminal group 41 are electrically connected to each other, such that the power supply module 10 can supply power to the underground lamp 2 through the first terminal group 22 and the second terminal group 41. In this way, multiple underground lamps 2 can be stored and charged simultaneously in the charging slots 20 outside the box 1.

In some embodiments as shown in the figures, the bottom 201 of the underground lamp 2 has a disk-shaped outer contour, the contour of the charging slot 20 corresponds to the contour of the bottom 201 of the underground lamp 2, the positioning part 30 of the charging slot 20 includes a round bump 31 protruding outward from the bottom surface 21, and the first terminal group 22 is installed at the outer periphery of the bottom surface 21 and configured relative to the bump 31.

The bump 31 includes a top surface 311 away from the bottom surface 21 and two correspondingly arranged baffles 32 protruding outward from the top surface 311. The positioning slot 40 of underground lamp 2 includes an opening 42, and two correspondingly arranged positioning plates 43 protruding towards the interior of the opening 42 of the positioning slot 40.

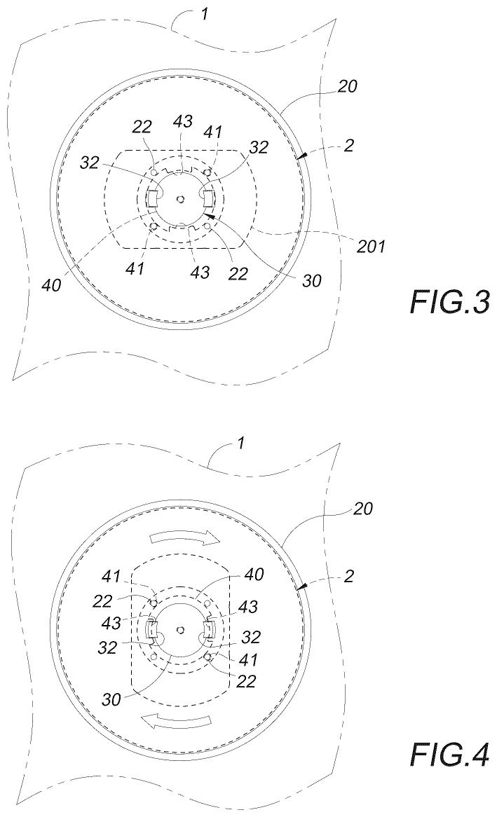

When the bottom 201 of the underground lamp 2 is embedded in the bottom surface 21 of the charging slot 20 to embed the positioning part 30 of the charging slot 20 in the positioning slot 40 of the underground lamp 2, as shown in FIGS. 3 and 4, the underground lamp 2 is deflectable relative to the charging slot 20 to deflect and displace the two positioning plates 43 of the underground lamp 2 in order to fix the positions of the two baffles 32 of the charging slot 20 by mutual blocking, meanwhile the first terminal group 22 and the second terminal group 41 are electrically connected to each other, such that the power supply module 10 (also refer to FIG. 1) can supply power to the underground lamp 2 and charge the underground lamp 2 through the first terminal group 22 and the second terminal group 41.

When the charging of the underground lamp 2 is completed, users just need to deflect the underground lamp 2 relative to the charging slot 20 to misalign the two positioning plates 43 of the underground lamp 2 with the two baffles 32 of the charging slot 20 in order to release the blocking status and remove the underground lamp 2 from the charging slot 20 for use.

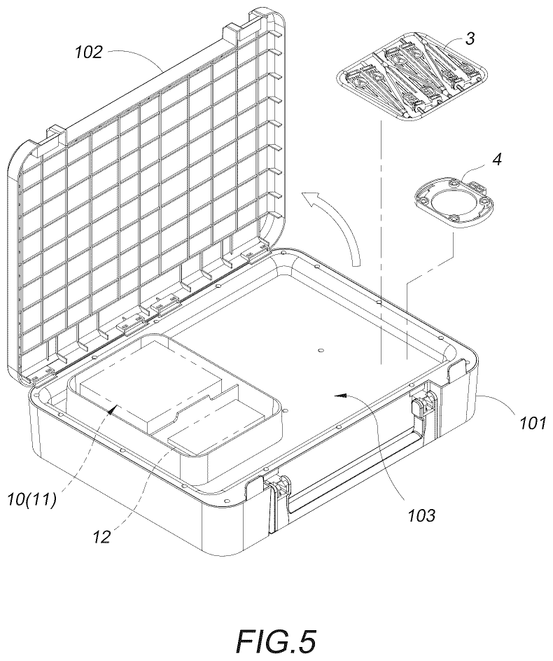

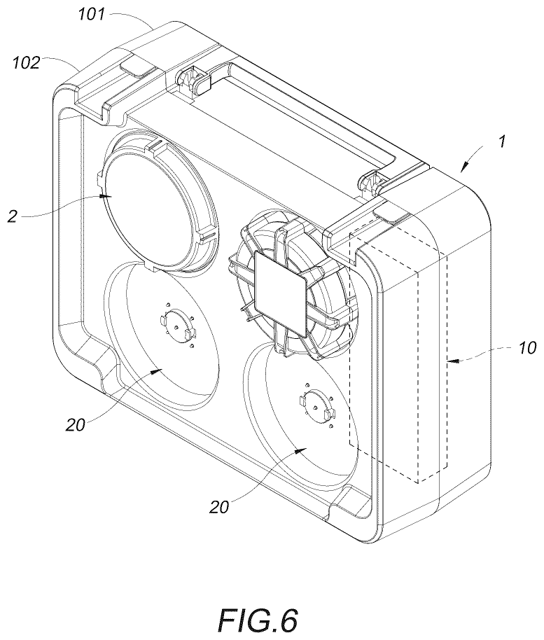

In an embodiment as shown in FIGS. 1 and 5, the box 1 includes a front box casing 101 and a rear box casing 102 pivotally connected to the rear of the front box casing 101, and an accommodation space 103 is defined between the front box casing 101 and the rear box casing 102 and provided for installing the power supply module 10 in box 1.

Wherein, the outer surface of the front box casing 101 and/or the rear box casing 102 is provided with the plurality of charging slots 20. In an embodiment as shown in FIGS. 1 and 5, the plurality of charging slots 20 is formed on the outer surface of the front box casing 101, the outer surface of the rear box casing 102 is in a flat shape. In an embodiment as shown in FIG. 6, in addition to the front box casing 101 having a plurality of charging slots 20, the outer surface of the rear box casing 102 is also provided with a plurality of charging slots 20 for expanding the quantity of the charging slots 20.

In FIGS. 5 and 6, the front box casing 101 and the rear box casing 102 can be opened or closed to open or cover the accommodation space 103 to facilitate users to obtain the objects stored in the accommodation space 103 and to prevent the objects from falling out. In the embodiment, the accommodation space 103 can be used to install the power supply module 10 as well as storing the plurality of ground plugs 3 and a wall fixing plate 4.

The ground plug 3 and the wall fixing plate 4 can be selectively installed on any one of the underground lamps 2, so that the underground lamp 2 can be plugged into the ground through the ground plug 3, or fixed on a wall through the wall fixing plate 4. The methods of combining the ground plug 3, and combining the underground lamp 2 with the ground plug 3 and the wall fixing plate 4 are well-known arts and thus they will not be described here.

In FIGS. 1 and 5, the power supply module 10 is installed in the accommodation space 103 and includes a battery 11, a circuit board 12, and a charging jack 13 disposed on the outer surface of the front box casing 101 or the rear box casing 102, of which all are disposed in the accommodation space 103. The battery 11, the circuit board 12 and the charging jack 13 are electrically connected to each other, such that the box 1 can obtain external power through the charging jack 13 to charge the battery 11.

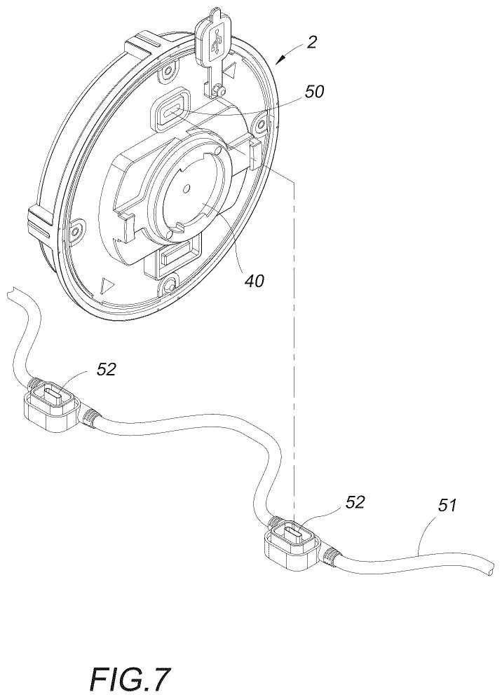

In FIGS. 1, 5 and 7, the underground lamp storage and charging system of the present disclosure further includes a charging cable 51 accommodated in the accommodation space 103, the charging cable 51 is provided with a plurality of electrical connectors 52 with a spacing from each other, the underground lamp 2 is provided with a port 50 pluggable to any one of the electrical connectors 52, such that external power received by the external charging cable 51 can charge the plurality of underground lamps 2 simultaneously. In addition to obtaining electric power from the box 1, the underground lamp 2 can also obtain electric power through the external charging cable 51 for charging. In an embodiment, the port 50, the electrical connector 52 and the charging jack 13 are USB Type-C devices.

While the present disclosure has been described by means of specific embodiments which are to be considered illustrative rather than restrictive, numerous modifications and variations could be made thereto by those skilled in the art without departing from the scope and spirit of the disclosure as set forth in the claims.

What is claimed is:

1. An underground lamp storage and charging system, comprising:
a box and a plurality of underground lamps, the box having an accommodation space defined therein for accommodating a power supply module, a plurality of recessed charging slots formed on the exterior of the box and each charging slot being provided for detachably fixing an underground lamp, wherein:
the charging slot comprises a bottom surface with a first terminal group exposed therefrom and electrically coupled to the power supply module, and a positioning part convexly formed at the center of the bottom surface;
the underground lamp, comprises a bottom embeddable into any one of the charging slots, the bottom having a positioning slot configured relative to the positioning part, and a second terminal group configured relative to the first terminal group;
thereby, when the bottom of the underground lamp is embedded into the bottom surface of the charging slot, the positioning part of the charging slot is embedded into the positioning slot of the underground lamp to prevent the underground lamp from falling off, and the first terminal group and the second terminal group are electrically coupled to each other, such that the power supply module can supply power to the underground lamp through the first terminal group and the second terminal group.

2. The underground lamp storage and charging system according to claim 1, wherein the underground lamp bottom has a disk-shaped outer contour, the contour of the charging slot and the contour of the underground lamp bottom correspond to each other, the positioning part of the charging slot comprises a cylindrical bump protruding outward from the bottom surface, the bump has a top surface away from the bottom surface, and the top surface comprises two correspondingly arranged baffles protruding outward;
the positioning slot of the underground lamp comprises an opening and two correspondingly arranged positioning plates protruding towards the interior of the opening of the positioning slot;
after the bottom of the underground lamp is embedded into the bottom surface of charging slot to embed the positioning part of the charging slot into the positioning slot of the underground lamp, the underground lamp is deflectable relative to the charging slot to deflect and displace the two positioning plates of the underground lamp in order to fix the positions of the two baffles of the charging slot by mutual blocking, such that the first terminal group and the second terminal group are electrically coupled to each other.

3. The underground lamp storage and charging system according to claim 2, wherein the box comprises a front box casing and a rear box casing pivotally coupled to the rear of the front box casing, the front box casing comprises an outer surface provided for forming the plurality of charging slots, the rear box casing comprise a flat outer surface, and the accommodation space is defined between the flat outer surface of the rear box casing and the front box casing, and the rear box casing can be opened relative to the front box casing or can cover the accommodation space.

4. The underground lamp storage and charging system according to claim 3, wherein the accommodation space further comprises a plurality of ground plugs and a wall fixing plate accommodated therein, and each ground plug and each wall fixing plate are selectively installed on any one of the underground lamps.

5. The underground lamp storage and charging system according to claim 3, wherein the power supply module comprises a battery, a circuit board and a charging jack disposed on the outer surface of the front box casing, of which all are installed in the accommodation space, and the battery, the circuit board and the charging jack are electrically coupled to each other.

6. The underground lamp storage and charging system according to claim 3, wherein the accommodation space further comprises a charging cable accommodated therein, the charging cable comprises a plurality of electrical connectors spaced from each other, and the underground lamp comprises a port pluggable to any one of the electrical connectors which is provided for charging a plurality of underground lamps after receiving external power through the charging cable.

7. The underground lamp storage and charging system according to claim 2, wherein the box comprises a front box casing and a rear box casing pivotally coupled to the rear of the front box casing, the rear box casing of the front box casing comprises an outer surface provided for forming the plurality of charging slots, the accommodation space is defined between the front box casing and the rear box casing, and the front box casing and the rear box casing can be opened or closed relative to each other to respectively open or close the accommodation space.

8. The underground lamp storage and charging system according to claim 7, wherein the accommodation space further comprises a plurality of ground plugs and a wall fixing plate accommodated therein, each ground plug and each wall fixing plate are selectively installed on any one of the underground lamps.

9. The underground lamp storage and charging system according to claim 7, wherein the power supply module comprises a battery, a circuit board, and a charging jack disposed on the outer surface of the front box casing, of which all are disposed in the accommodation space, and the battery, the circuit board and the charging jack are electrically coupled to each other.

10. The underground lamp storage and charging system according to claim 7, wherein the accommodation space further comprises a charging cable accommodated therein, the charging cable comprises a plurality of electrical connectors spaced from each other, and the underground lamp comprises a port pluggable to any one of the electrical connectors in order to charge a plurality of underground lamps simultaneously after receiving external power through the charging cable.
